(19) United States
(12) Patent Application Publication
(10) Pub. No.: US 2009/0175150 A1
(43) Pub. Date: Jul. 9, 2009

(54) MULTI-CHANNEL OPTICAL PICKUP AND OPTICAL RECORDING/REPRODUCING APPARATUS EMPLOYING THE SAME

(75) Inventors: Kyongtae PARK, Suwon-si (KR); Tae-kyung Kim, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/267,114

(22) Filed: Nov. 7, 2008

(30) Foreign Application Priority Data
Jan. 7, 2008 (KR) 2008-1862

(51) Int. Cl. G11B 7/00

(52) U.S. Cl. 369/112.23; G9B/7.097

(57) ABSTRACT

A multi-channel optical pick-up and a multi-channel optical recording and/or reproducing apparatus employing the same, the multi-channel optical pick-up including: a plurality of light sources including a center light source closest to an optical axis from among the plurality of light sources and at least one off-axis light source farther than the center light source to the optical axis; an objective lens to condense a plurality of light beams respectively emitted from the plurality light sources onto a plurality of tracks of an information storage medium; and an optical path length changing element to compensate for defocus that occurs due to the at least one off-axis light source distanced from the optical axis when a center light beam from the center light source and at least one off-axis light beam from the at least one off-axis light source form spots on the information storage medium.

### CROSS-REFERENCE TO RELATED APPLICATION

This application claims the benefit of Korean Patent Application No. 2008-1862, filed Jan. 7, 2008 in the Korean Intellectual Property Office, the disclosure of which is incorporated herein by reference.

### BACKGROUND OF THE INVENTION

1. Field of the Invention

Aspects of the present invention relate to a multi-channel optical pick-up and a multi-channel optical recording and/or reproducing apparatus employing the same, and more particularly, to a multi-channel optical pick-up that records and/or reproduces data on a plurality of tracks by emitting a plurality of light beams onto different tracks, thereby enhancing a data transmission rate (DTR), and a multi-channel optical recording and/or reproducing apparatus employing the same.

2. Description of the Related Art

Recently, in an optical recording technology, a number of multi-layers of an optical disc (for example, a Blu-ray disc) has increased to expand the capacity of the medium. Accordingly, there is a simultaneously increasing need to improve a data transmission rate (DTR) in line with the expansion of capacity.

As a method of improving the DTR, a multi-channel optical pick-up method uses a plurality of light sources to simultaneously reproduce signals on different tracks and to record data on the different tracks. The method of using a plurality of light sources includes a method of using laser diodes (LD), a method of forming several light sources by combining several individual LD arrays, and a method of gathering light beams from several different LDs using a waveguide.

Light beams emitted from LD arrays pass through an objective lens, and are focused on an optical disc with a particular distance apart from one another. Thus, like an LD array, when a plurality of light beams are simultaneously emitted from a plurality of light sources (including a center light source placed on an optical axis or close to the optical axis and off-axis light sources) and pass through an objective lens, the light beams from off-axis light sources are defocused with respect to a center spot of a center light beam. The lights beams from the off-axis light sources are defocused because these light beams are off from the optical axis and form spots at different positions of the optical disc.

To implement a multi-channel optical recording by using a plurality of light sources for improving a DTR, substantial defocus of each spot with respect to a center spot on an information storage medium is harmful to the recording.

### SUMMARY OF THE INVENTION

Aspects of the present invention provide a multi-channel optical pick-up that provides spots on an information storage medium to stably record and/or reproduce signals by preventing defocus of the spots with respect to a center spot, and a multi-channel optical recording and/or reproducing apparatus employing the same.

According to an aspect of the present invention, there is provided a multi-channel optical pick-up to focus a plurality of light beams on an information storage medium, the multi-channel optical pickup including: a plurality of light sources to respectively emit the plurality of light beams, the plurality of light sources including a center light source located closest to an optical axis from among the plurality of light sources, and at least one off-axis light source farther than the center light source from the optical axis; an objective lens to condense the plurality of light beams from the light sources onto a respective plurality of tracks of the information storage medium; and an optical path length changing element to compensate for defocus that occurs due to the at least one off-axis light source when a center light beam from the center light source and at least one off-axis light beam from the at least one off-axis light source form spots on the information storage medium.

The optical path length changing element may be step-shaped in which a center portion on the optical axis or near the optical axis is thinnest and the thickness increases from the center toward a periphery.

The optical path length changing element may be placed with respect to the plurality of light sources such that the plurality of light beams from the plurality of light sources do not overlap one another and each light beam passes through a corresponding step of the optical path length changing element, and individual steps have widths that can accommodate a divergence angle of each of the plurality of light beams.

When a refractive index of the optical path length changing element is n_{medium}, a thickness of each step of the optical path length changing element is t, and a refractive index of air is nₐᵢᵣ, the thickness of each step of the optical path length changing element may be determined according to (n_{medium}−nₐᵢᵣ)×t such that an aberration of a corresponding spot on the information storage medium is smallest when the spot is formed on the information storage medium.

A direction of the steps of the optical path length changing element may be determined to be a same direction as a direction that corresponds to a small light emitting angle of a light beam emitted from each light source.

The multi-channel optical pick-up may further include: a collimating lens to collimate the plurality of light beams from the plurality of light sources, the collimating lens being placed between the optical path length changing element and the objective lens.

The multi-channel optical pick-up may further include: an optical path changing element provided between the optical path length changing element and the objective lens to change an optical path of incident light; and a photodetector to receive and to detect a light beam reflected from the information storage medium and passed through the objective lens and the optical path length changing element.

The plurality of light sources may form a laser diode array.

Light emitting points of the laser diode array may be placed a same distance from one another.

According to another aspect of the present invention, there is provided a multi-channel optical recording and/or reproducing apparatus including: a multi-channel optical pick-up according to aspects of the present invention described above that reproduces information from an information storage medium and/or records information to the information storage medium; and a control part to control the multi-channel optical pick-up.

According to yet another aspect of the present invention, there is provided a method of focusing a plurality of light beams on an information storage medium, the method including: emitting the plurality of light beams, the plurality of light beams including a center light beam emitted closest to an optical axis from among the plurality of light beams, and at least one off-axis light beam emitted farther than the center light beam from the optical axis; compensating for defocus that occurs due to the at least one off-axis light beam when the plurality of light beams form respective spots on the information storage medium; and condensing the plurality of compensated light beams onto a respective plurality of tracks on the information storage medium.

According to still another aspect of the present invention, there is provided a multi-channel optical pick-up to focus a plurality of light beams on an information storage medium, the multi-channel optical pick-up including: an optical path length changing element to compensate for defocus that occurs due to at least one off-axis light beam, of the plurality of light beams, when a center light beam closest to an optical axis from among the plurality of light beams and the at least one off-axis light beam form spots on the information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph showing an S-curve obtained from signals that are detected by a photodetector while an objective lens is swept when several light beams are emitted from a laser diode (LD) array formed of a plurality of laser diodes (LDs) 100 μm apart from one another;

FIG. 2 is an illustration schematically showing an optical structure of a multi-channel optical pick-up according to an embodiment of the present invention;

FIG. 3 is an enlarged view showing the plurality of light sources, which form the LD array, and the optical path length changing element of FIG. 2;

FIG. 4 is a schematic perspective view of the plurality of light sources and the optical path length changing element 20 of FIG. 2;

FIG. 5 shows a multi-channel optical pick-up according to an embodiment of the present invention; and

FIG. 6 is a schematic diagram of a multi-channel optical recording and/or reproducing apparatus employing a multi-channel optical pick-up, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

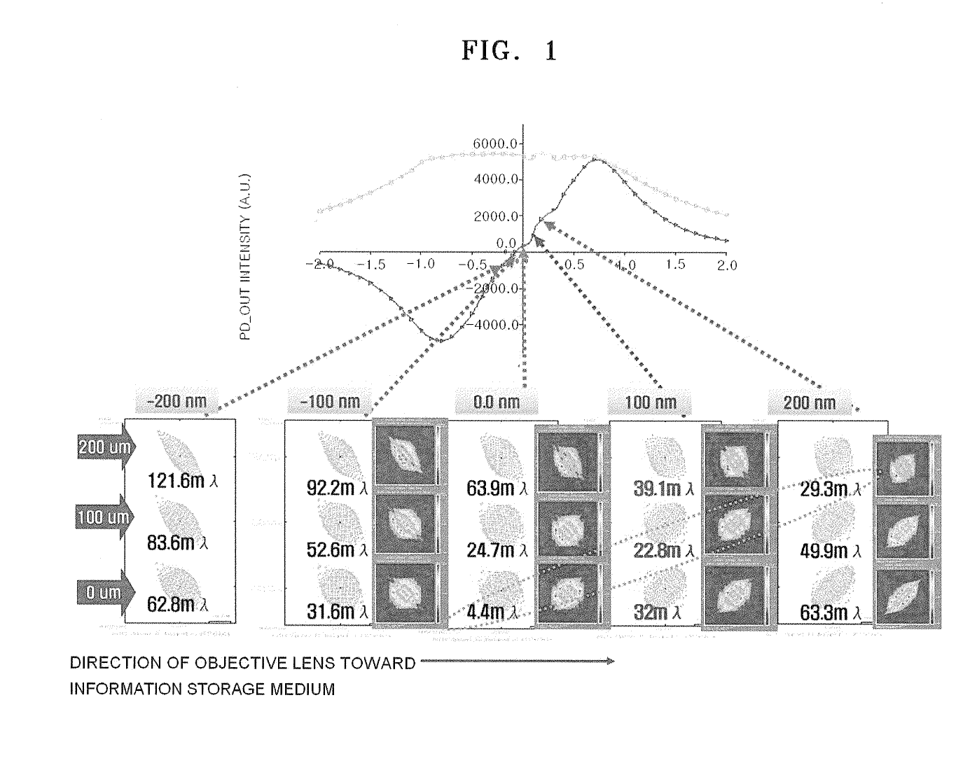

FIG. 1 is a graph showing an S-curve obtained from signals that are detected by a photodetector while an objective lens is swept when several light beams are emitted from a laser diode (LD) array formed of a plurality of laser diodes (LDs) 100 μm apart from one another. Referring to FIG. 1, changes in aberration that occur on optical spots on an information storage medium according to changes in a working distance of an objective lens and a distribution of a received light beam in the photodetector are illustrated in a lower part thereof. On the optical spot, light emitted from a center light source arranged in line with an optical axis and light from off-axis light sources, which are respectively 100 μm and 200 μm apart from the light axis, are focused. In FIG. 1, −200 nm, −100 nm, 0.0 nm, 100 nm, and 200 nm indicate how long the working distances of the objective lens are apart from a predetermined optimal value.

As shown in FIG. 1, the aberrations of the optical spots are different from one another according to the working distance. Furthermore, the distributions of light beams incident on the photodetector also differ from one another according to the working distance. When the aberration of a center spot becomes minimal (i.e., 4.4 mλ in FIG. 1), received light from the light source 200 μm apart is oval shaped, as opposed to circle-shaped. Accordingly, the light is defocused when the light from the light source 200 μm apart from the optical axis forms a spot on an information storage medium. As the light source becomes farther from the optical axis, the amount of defocus on the spot on the information storage medium becomes greater. When the aberration of the center spot is minimal (i.e., about 4.4 mλ in FIG. 1), the aberrations of the spots with respect to light emitted from the light sources 100 μm and 200 μm apart from the optical axis are about 24.7 mλ and 63.9 mλ, respectively. That is, as the light source becomes farther from the optical axis, the aberration of the spot increases.

Hence, when the spots of light emitted from the light sources arranged apart from the optical axis are formed on the information storage medium, the aberration is minimized by removing defocus. According to an aspect of the present invention, spots of the light beams emitted from several light sources may be formed on a same surface so that the aberration can be minimized.

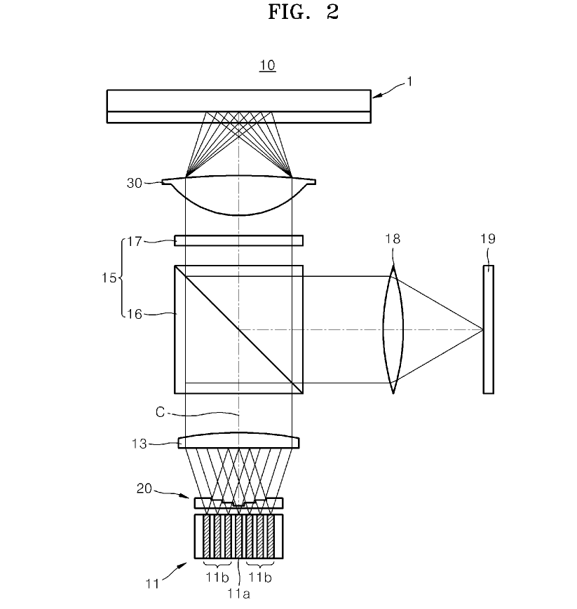

FIG. 2 is an illustration schematically showing an optical structure of a multi-channel optical pick-up 10 according to an embodiment of the present invention. Referring to FIG. 2, the multi-channel optical pick-up 10 includes a plurality of light sources 11a and 11b, an objective lens 30, and an optical path length changing element 20. The objective lens 30 condenses a plurality of light beams from the light sources 11a and 11b and irradiates the light beams onto a plurality of tracks. The optical path length changing element 20 compensates for defocus.

The multi-channel optical pick-up 10 may further include a collimating lens 13 to collimate the plurality of light beams emitted from the light sources 11a and 11b on an optical path between the optical path length changing element 20 and the objective lens 30. Moreover, the multi-channel optical pick-up 10 may further include an optical path changing element 15 to change the optical path of incident light between the optical path length changing element 20 and the objective lens and a photodetector 19. The photodetector 19 detects light that is reflected from an information storage medium 1 and passes through the objective lens 30 and the optical path changing element 15.

The plurality of light sources 11a and 11b includes a center light source 11a that is located on an optical axis C or is closest to an optical axis C from among the plurality of light sources 11a and 11b. The plurality of light sources 11a and 11b further includes one or more light sources 11b that are farther from the optical axis C than the center light source 11a is. The light sources 11b other than the center light source 11a are placed off-axis, and are indicated as off-axis light sources 11b. In FIG. 2, the center light source 11a is placed on the optical axis C, and the off-axis light sources 11b are placed symmetrically to the center light source 11a.

The plurality of light sources 11a and 11b form a laser diode (LD) array 11, as shown in FIG. 2. Light emitting points of the LD array 11 may be arranged a same distance apart from one another. Although the plurality of light sources 11a and 11b form the LD array 11, it is understood that aspects of the present invention are not limited thereto. According to other aspects, the multi-channel optical pick-up 10 can have various modifications as long as the multi-channel optical pick-up 10 includes a center light source and one or more off-axis light sources that are farther from the optical axis C than the center light source.

The objective lens 30 is provided in a manner that it is compatible with a format of the information storage medium 1 employed in a multi-channel optical recording and/or reproducing apparatus. For example, when the optical multi-channel optical recording and/or reproducing apparatus is used to record and/or reproduce data to/from a single-layer or multi-layer Blu-ray disc, the objective lens 30 may have a numerical aperture of about 0.85 and may be designed for a Blu-ray disc having a 0.1 mm thick protective layer. In this case, the plurality of light sources 11a and 11b may use blue laser diodes that emit light with a wavelength of about 405 nm or near 405 nm.

The optical path length changing element 20 compensates for defocus resulting from the different distances between the light sources 11a and 11b and the optical axis C when a center light beam emitted from the center light source 11a and one or more light beams emitted from the off-axis light sources 11b are formed as spots on the information storage medium 1. The optical path length changing element 20 compensates for defocus caused by the off-axis light sources 11b so that the plurality of light beams can be focused on the same surface of the information storage medium 1.

To this end, the optical path length changing element 20 may be formed in a step fashion where the thickness increases from the center, close to the optical axis C, toward the periphery, as shown in FIG. 2.

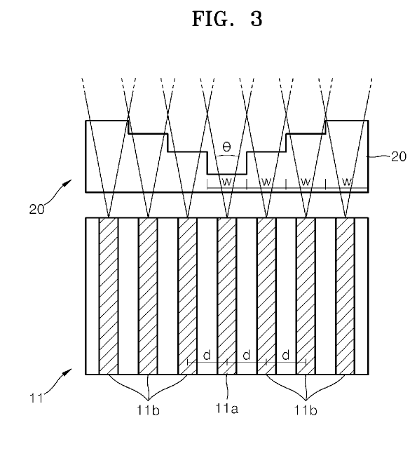

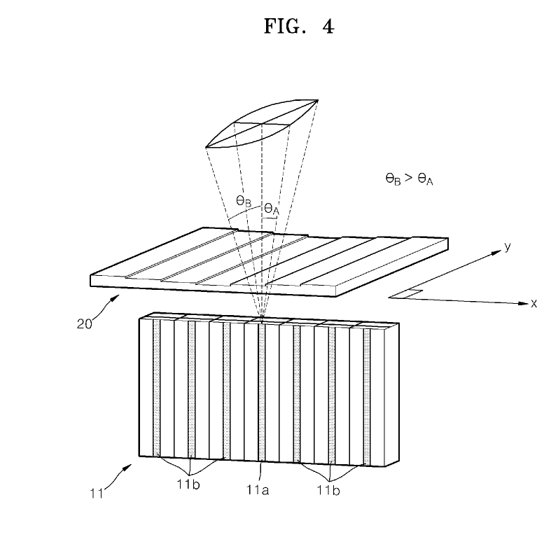

FIG. 3 is an enlarged view showing the plurality of light sources 11a and 11b that form the LD array 11, and the optical path length changing element 20 of FIG. 2, and FIG. 4 is a schematic perspective view of the plurality of light sources 11a and 11b and the optical path length changing element 20. Referring to FIG. 3, the optical path length changing element 20 is provided with respect to the plurality of light sources 11a and 11b in a manner that the plurality of light beams emitted from the light sources 11a and 11b do not overlap with one another and each light beam passes through a corresponding step. To do so, the optical path length changing element 20 may be disposed directly in front of the plurality of light sources 11a and 11b.

In this case, each step of the optical path length changing element 20, as shown in FIG. 3, has a width that can accommodate the divergence angle (θ) of each light beam. In FIG. 3, the plurality of light sources 11a and 11b are arranged a same distance (d) apart from each other and the widths (w) of the steps are identical (or substantially identical) with one another.

When a refractive index of the optical path length changing element 20 is n_{medium}, a thickness of each step of the optical path length changing element 20 is tₛₜₑₚ and a refractive index of air is nₐᵢᵣ, the thickness of the optical path length changing element 20 may be determined by an equation of (n_{medium}−nₐᵢᵣ)×tₛₜₑₚ so that the optical path length changing element 20 can have a minimum aberration when each light beam from each light source is focused on the information storing medium 1 as a spot.

Referring to FIG. 4, light beams emitted from each laser diode 11a and 11b have different divergence angles in horizontal (x-axis direction) and vertical (y-axis direction) directions due to differences between the width and length of a light emitting aperture.

Therefore, the direction of steps of the optical path length changing element 20 (that is, an elevating direction of the steps) can be determined according to a smaller divergence angle of a light beam from each laser diode. In other words, the LD array includes a plurality of laser diodes that are arranged in a direction of the smaller divergence angle, and the direction of the steps of the optical path length changing element 20 can be determined corresponding to the arrayed laser diodes. In this case, a direction of the larger divergence angle of each laser diode corresponds to the length direction of the optical path length changing element 20.

As the direction of the smaller beam divergence angle is determined as the direction of the steps of the optical path length changing element 20, a distance between laser diodes of the LD array 11 can be minimized. Furthermore, freedom of an arrangement distance between the optical path length changing element 20 and the LD array 11 can increase while each light beam is passing through a corresponding step without overlapping other laser beams. That is, arranging the optical path length changing element 20 becomes easier.

Generally, in a laser diode (for example, an edge emitting type laser diode), the width of an aperture in a direction (in FIG. 4, a y-axis direction) in which semiconductor material layers are stacked is smaller than the width of an aperture in a direction (in FIG. 4, an x-axis direction) perpendicular to the stacking direction. Thus, the laser diode emits a light beam with a greater divergence angle θ_{B} in a stacking direction of the semiconductor material layers than a divergence angle θ_{A} in the direction perpendicular to the stacking direction.

Hence, when the LD array 11 is formed of units of a predetermined number of laser diodes by dicing the laser diodes formed by a semiconductor fabrication method on a wafer in a desired unit, the plurality of laser diodes of the LD array 11 are arranged in a direction of a smaller divergence angle. Moreover, when a structure of the plurality of light sources 11a and 11b is formed by putting together individually fabricated laser diodes on a laser diode array, arranging the plurality of light sources 11a and 11b in a direction of a smaller divergence angle makes it easier to form the array of the plurality of light sources 11a and 11b. Therefore, when the step direction of the optical path length changing element 20 is determined to be the direction of a smaller beam emission angle, the arrangement structure of the plurality of light sources 11a and 11b used by the multi-channel optical pick-up 10 according to aspects of the present invention can be easily obtained.

Referring to FIG. 2 again, the optical path changing element 15 includes a polarizing beam splitter 16 to selectively transmit or reflect an incident light beam according to a polarization of the incident light beam, and a quarter-wave plate 17 to changes the polarization of the incident light beam on an optical path between the polarizing beam splitter 16 and the objective lens 30. Alternatively or additionally, according to another embodiment, the optical path changing element 15 may include a beam splitter to transmit and reflect an incident light beam in a predetermined ratio.

The photodetector 19 detects a reproducing signal with respect to each track by receiving a plurality of light beams reflected from a respective plurality of tracks of the information storage medium 1. Furthermore, the photodetector 19 may be designed to detect an error signal for servo (for example, a focus error signal and/or a tracking error signal) by using a light beam reflected from at least one of the plurality of tracks. To this end, the photodetector 19 may include a plurality of light receiving areas.

Also, a detecting lens 18 may also be included on a optical path between the optical path changing element 15 and the photodetector 19 in order for an appropriate light spot to be focused on the photodetector 19. The detecting lens 18 may be an astigmatism lens in order to detect a focus error signal according to an astigmatism method. Alternatively or additionally, the detecting lens 18 may include a condensing lens.

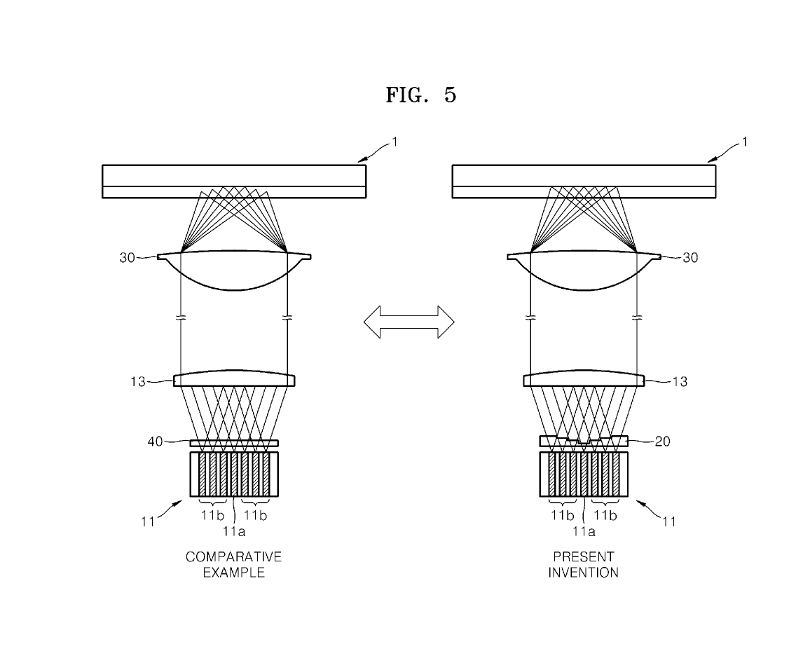

FIG. 5 shows a multi-channel optical pick-up 10 according to an embodiment of the present invention and a comparative example. The comparative example includes a transparent flat plate (for example, a cover glass 40), instead of the optical path length changing element 20 according to an embodiment of the present invention.

In the comparative example, since the flat plate 40 changes the lengths of optical paths of a center light beam emitted from the center light source 11a and off-axis light beams emitted from the off-axis light sources 11b without difference among the center and off-axis light beams, the off-axis light beams from the off-axis light sources 11b are defocused with respect to the spot of the center light beam on the information storage medium 1, as described with reference to FIG. 1, and have focal lengths different from that of the center spot. Hence, a plurality of spots may not be focused on a same surface of the information storage medium 1. For example, a light beam emitted from a light source farther from the optical axis may form a spot on a shallower portion of the information storage medium 1.

When the focusing locations of the spots move to deeper parts of the information storage medium 1, the spots can be focused on the same surface as that of the center light beam of the center light source 11a. Therefore, when the light emitting points of the plurality of light sources 11a and 11b are located on the same plane, the light emitting points of the off-axis light sources 11b should be closer to the information storage medium 1 than the light emitting point of the center light source 11a.

The optical path length changing element 20 according aspects of the present invention has an effect similar to placing the light emitting points of the off-axis light sources 11b closer than the point of the center light source 11a to the information storage medium 1. Specifically, the optical path length can be changed by a transparent plate (such as a cover glass), and the optical path length difference between a light beam passing through the cover glass and a light beam passing through air can be represented as (n_{cover glass}−nₐᵢᵣ)×proceeding distance. For example, if a light beam passes through a cover glass with a reflective index of 1.6 and 100 μm in thickness, the optical path length difference between the light beam passing through the cover glass and a light beam passing through only the air is (1.6−1)×100 μm=60 μm. As a result, an effect similar to placing the light emitting point of the light beam 60 μm ahead can be obtained. Table 1 represents aberration changes of the spot according to the location of the laser diode when the thickness of the cover glass is changed.

TABLE 1

| | |
|---|---|
| | Aberration according to |
| Thickness of | location of laser diode |

| cover glass | 0 μm | 100 μm | 200 μm | 300 μm |
|---|---|---|---|---|
| 0.2 mm | 5 mλ | 23.2 mλ | 60.5 mλ | 110.4 mλ |
| 0.22 mm | 21.9 mλ | 16.6 mλ | 43.1 mλ | 95.9 mλ |
| 0.25 mm | 53.7 mλ | 40 mλ | 27.9 mλ | 75 mλ |
| 0.31 mm | 117.9 mλ | 101.9 mλ | 65.4 mλ | 55.4 mλ |

When a cover glass of an even thickness is placed near the light emitting point of an LD array 11 and the spots of a center light beam and an off-axis light beams are focused on the same surface of the information storage medium, the aberrations of spots of the center light beam and the off-axis light beams distanced in the same distance (of about 100 μm) from one another increase more due to defocuses as the off-axis light beams are farther from an optical axis. The thickness of the cover glass for the optimal aberration of each off-axis light beam can be obtained by calculating the aberration of each light source while a working distance of an objective lens is fixed and the thickness of the cover glass is raised gradually. Thus, the cover glass has different thicknesses in different portions so as to have the minimal aberration of the respective spot of each light source when each spot is formed on the information storage medium.

Hence, the optical path length changing element 20, according to an embodiment of the present invention, may be step-shaped in which the center part is thin and the thickness gradually increases outwards. Although the aberrations of off-axis light beams may not be the same as that of the center light beam due to an effect of a field, the effect of the defocus can be substantially reduced by using the above-mentioned method.

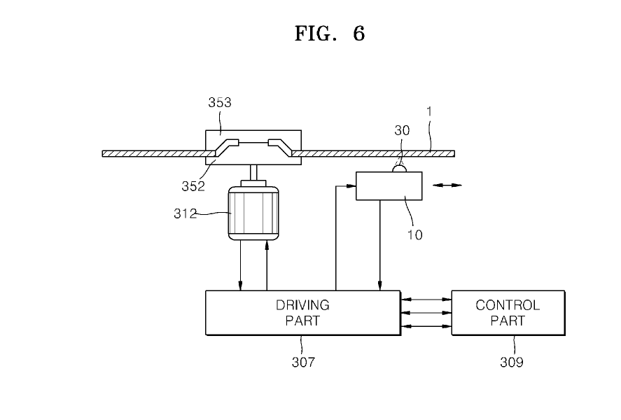

FIG. 6 is a schematic diagram of a multi-channel optical recording and/or reproducing apparatus employing a multi-channel optical pick-up 10, according to an embodiment of the present invention. Referring to FIG. 6, the multi-channel optical recording and/or reproducing apparatus includes a spindle motor 312 to rotate an information storage medium 1, the multi-channel optical pick-up 10 according to aspects of the present invention to record and/or reproduce information to/from the information storage medium 1 while being movably installed in a radial direction of the information storage medium 1, a driving part 307 to drive the spindle motor 312 and the multi-channel optical pick-up 10, and a control part 309 to control a focusing and tracking servo of the optical pick-up 10. Furthermore, the multi-channel optical recording and/or reproducing apparatus also includes a turn table 352 and a clamp 353 to chuck the information storage medium 1.

A light beam reflected from the information storage medium 1 is detected by a photodetector 19 included in the multi-channel optical pick-up 10, is converted into an electrical signal by photoelectric conversion, and is operated by a signal detecting circuit. The signal obtained by the signal detecting circuit is input to the control part 309 through the driving part 307. The driving part 307 controls the rotation speed of the spindle motor 312, amplifies the input signal, and drives the multi-channel optical pick-up 10. The control part 309 resends, to the driving part 307, focusing servo and tracking servo commands adjusted based on the signal input from the driving part 307 so that focusing and tracking of the multi-channel optical pick-up 10 can be performed.

According to aspects of the present invention, a multi-channel optical pick-up and a multi-channel optical recording and/or reproducing apparatus can prevent defocusing of each spot on an information storage medium with respect to a center spot, thereby stably recording and/or reproducing signals.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multi-channel optical pick-up to focus a plurality of light beams on an information storage medium, the multi-channel optical pick-up comprising:
a plurality of light sources to respectively emit the plurality of light beams, the plurality of light sources including a center light source located closest to an optical axis from among the plurality of light sources, and at least one off-axis light source farther than the center light source to the optical axis;
an objective lens to condense the plurality of light beams from the light sources onto a respective plurality of tracks of the information storage medium; and
an optical path length changing element to compensate for defocus that occurs due to the at least one off-axis light source when a center light beam from the center light source and at least one off-axis light beam from the at least one off-axis light source form spots on the information storage medium.

2. The multi-channel optical pick-up as claimed in claim 1, wherein the optical path length changing element is step-shaped in which a center portion on the optical axis or near the optical axis is thinnest and a thickness of the optical path length changing element increases from the center portion toward a periphery.

3. The multi-channel optical pick-up as claimed in claim 2, wherein the optical path length changing element is placed with respect to the plurality of light sources such that the plurality of light beams from the plurality of light sources do not overlap one another and each of the light beams passes through a corresponding step of the optical path length changing element.

4. The multi-channel optical pick-up as claimed in claim 3, wherein each step of the optical path length changing element has a respective width that accommodates a divergence angle of a corresponding one of the plurality of light beams.

5. The multi-channel optical pick-up as claimed in claim 3, wherein when a refractive index of the optical path length changing element is n_{medium}, a thickness of each step of the optical path length changing element is t, and a refractive index of air is nₐᵢᵣ, the thickness of each step of the optical path length changing element is determined according to (n_{medium}−nₐᵢᵣ)×t, such that an aberration of a corresponding spot on the information storage medium is smallest when the spot is formed on the information storage medium.

6. The multi-channel optical pick-up as claimed in claim 2, wherein a direction of steps of the optical path length changing element is determined to be a same direction as a direction that corresponds to a decreasing light emitting angle of beam emitted from each light source.

7. The multi-channel optical pick-up as claimed in claim 1, further comprising:
a collimating lens to collimate the plurality of light beams from the plurality of light sources, the collimating lens provided between the optical path length changing element and the objective lens.

8. The multi-channel optical pick-up as claimed in claim 7, further comprising:
an optical path changing element provided between the optical path length changing element and the objective lens to change an optical path of incident light; and
a photodetector to receives and to detect a light beam reflected from the information storage medium and passed through the objective lens and the optical path length changing element.

9. The multi-channel optical pick-up as claimed in claim 8, wherein the plurality of light sources form a laser diode array.

10. The multi-channel optical pick-up as claimed in claim 9, wherein light emitting points of the laser diode array are placed a same distance from one another.

11. The multi-channel optical pick-up as claimed in claim 1, wherein the plurality of light sources form a laser diode array.

12. The multi-channel optical pick-up as claimed in claim 11, wherein light emitting points of the laser diode array are placed a same distance from one another.

13. The multi-channel optical pick-up as claimed in claim 1, wherein the center light source is located on the optical axis.

14. The multi-channel optical pick-up as claimed in claim 1, wherein the optical path length changing element comprises at least one first area through which the at least one off-axis light beam passes and a second area through which the center light beam passes, the second area being thinner than the at least one first area.

15. The multi-channel optical pick-up as claimed in claim 1, further comprising:
an optical path changing element provided between the optical path length changing element and the objective lens to change an optical path of incident light; and
a photodetector to receives and to detect a light beam reflected from the information storage medium and passed through the objective lens and the optical path length changing element.

16. The multi-channel optical pick-up as claimed in claim 1, wherein the optical path length changing element has an effect on the plurality of light beams similar to placing corresponding light emitting points of the at least one off-axis light source closer than a point of the center light source to the information storage medium.

17. A multi-channel optical recording and/or reproducing apparatus comprising:
a multi-channel optical pick-up to reproduce information from an information storage medium and/or to record information to the information storage medium, the multi-channel optical pickup comprising:
a plurality of light sources to respectively emit a plurality of light beams, the plurality of light sources including a center light source located closest to an optical axis from among the plurality of light sources, and at least one off-axis light source farther than the center light source to the optical axis,
an objective lens to condense the plurality of light beams from the light sources onto a respective plurality of tracks of the information storage medium, and
an optical path length changing element to compensate for defocus that occurs due to the at least one off-axis light source when a center light beam from the center light source and at least one off-axis light beam from the at least one off-axis light source form spots on the information storage medium; and
a control part to control the multi-channel optical pick-up.

18. The multi-channel optical recording and/or reproducing apparatus as claimed in claim 17, wherein the optical path length changing element is step-shaped in which a center portion on the optical axis or near the optical axis is thinnest and a thickness of the optical path length changing element increases from the center toward a periphery.

19. The multi-channel optical recording and/or reproducing apparatus as claimed in claim 18, wherein the optical path length changing element is placed with respect to the plurality of light sources such that the plurality of light beams from the plurality of light sources do not overlap one another and each of the light beams passes through a corresponding step of the optical path length changing element.

20. The multi-channel optical recording and/or reproducing apparatus as claimed in claim 19, wherein each step of the optical path length changing element has a respective width that accommodates a divergence angle of a corresponding one of the plurality of light beams.

21. The multi-channel optical recording and/or reproducing apparatus as claimed in claim 19, wherein when a refractive index of the optical path length changing element is n_{medium}, a thickness of each step of the optical path length changing element is t, and a refractive index of air is nₐᵢᵣ, the thickness of each step of the optical path length changing element is determined according to (n_{medium}−nₐᵢᵣ)×t, such that an aberration of a corresponding spot on the information storage medium is smallest when the spot is formed on the information storage medium.

22. The multi-channel optical recording and/or reproducing apparatus as claimed in claim 18, wherein a direction of steps of the optical path length changing element is determined to be a same direction as a direction that corresponds to a decreasing light emitting angle of beam emitted from each light source.

23. The multi-channel optical recording and/or reproducing apparatus as claimed in claim 17, wherein the multi-channel optical pick-up further comprises a collimating lens to collimate the plurality of light beams from the plurality of light sources, the collimating lens provided between the optical path length changing element and the objective lens.

24. The multi-channel optical recording and/or reproducing apparatus as claimed in claim 23, wherein the multi-channel optical pick-up further comprises:
an optical path changing element provided between the optical path length changing element and the objective lens to change an optical path of incident light; and
a photodetector to receive and to detect a light beam reflected from the information storage medium and passed through the objective lens and the optical path length changing element.

25. The multi-channel optical recording and/or reproducing apparatus as claimed in claim 24, wherein the plurality of light sources form a laser diode array.

26. The multi-channel optical recording and/or reproducing apparatus as claimed in claim 25, wherein light emitting points of the laser diode array are placed in a same distance from one another.

27. The multi-channel optical recording and/or reproducing apparatus as claimed in claim 17, wherein the plurality of light sources form a laser diode array.

28. The multi-channel optical recording and/or reproducing apparatus as claimed in claim 27, wherein light emitting points of the laser diode array are placed at a same distance from one another.

29. The multi-channel optical recording and/or reproducing apparatus as claimed in claim 17, wherein the center light source is located on the optical axis.

30. The multi-channel optical recording and/or reproducing apparatus as claimed in claim 17, wherein the optical path length changing element comprises at least one first area through which the at least one off-axis light beam passes and a second area through which the center light beam passes, the second area being thinner than the at least one first area.

31. The multi-channel optical recording and/or reproducing apparatus as claimed in claim 17, wherein the multi-channel optical pick-up further comprises:
an optical path changing element provided between the optical path length changing element and the objective lens to change an optical path of incident light; and
a photodetector to receive and to detect a light beam reflected from the information storage medium and passed through the objective lens and the optical path length changing element.

32. The multi-channel optical recording and/or reproducing apparatus as claimed in claim 17, wherein the optical path length changing element has an effect on the plurality of light beams similar to placing corresponding light emitting points of the at least one off-axis light source closer than a point of the center light source to the information storage medium.

33. A method of focusing a plurality of light beams on an information storage medium, the method comprising:
emitting the plurality of light beams, the plurality of light beams including a center light beam emitted closest to an optical axis from among the plurality of light beams, and at least one off-axis light beam emitted farther than the center light beam from the optical axis;
compensating for defocus that occurs due to the at least one off-axis light beam when the plurality of light beams form respective spots on the information storage medium; and
condensing the plurality of compensated light beams onto a respective plurality of tracks on the information storage medium.

34. The method as claimed in claim 33, wherein the compensating comprises:
passing the at least one off-axis light beam through a first area of an optical path length changing element; and
passing the center light beam through a second area of the optical path length changing element, the second area being thinner than the at least one first area.

35. A multi-channel optical pick-up to focus a plurality of light beams on an information storage medium, the multi-channel optical pick-up comprising:
an optical path length changing element to compensate for defocus that occurs due to at least one off-axis light beam, of the plurality of light beams, when a center light beam closest to an optical axis from among the plurality of light beams and the at least one off-axis light beam form spots on the information storage medium.

36. The multi-channel optical pick-up as claimed in claim 35, wherein the optical path length changing element comprises at least one first area through which the at least one off-axis light beam passes and a second area through which the center light beam passes, the second area being thinner than the at least one first area.
